(19) United States
(12) Patent Application Publication
(10) Pub. No.: US 2023/0244432 A1
(43) Pub. Date: Aug. 3, 2023

(54) DISPLAY CONTROL DEVICE, DISPLAY DEVICE, AND DISPLAY CONTROL METHOD FOR IMAGES WITH DIFFERENT DYNAMIC RANGES

(71) Applicant: CANON KABUSHIKI KAISHA, Tokyo (JP)

(72) Inventors: MASAHIRO SATO, Tokyo (JP); HIROFUMI URABE, Tokyo (JP)

(21) Appl. No.: 18/158,976

(22) Filed: Jan. 24, 2023

(30) Foreign Application Priority Data
Jan. 28, 2022 (JP) 2022-011842

(51) Int. Cl. G06F 3/14; G06T 7/00; G06T 11/40; G06T 11/20; G06T 7/90

(52) U.S. Cl. CPC G06F 3/14; G06T 7/0002; G06T 11/40; G06T 11/203; G06T 7/90; G06T 2207/20208; G06T 2207/30168; G06T 2207/20072

(57) ABSTRACT

A display control device includes an acquiring unit, a selecting unit and a display control unit. The acquiring unit acquires a first image that is an image having a first dynamic range, and a second image that is an image having a second dynamic range that is narrower than the first dynamic range, and is an image representing content that is same as content represented by the first image. The selecting unit selects, in a case where the first image and the second image include one or a plurality of feature regions, at least one of the one or plurality of feature regions as an attention region, on the basis of a count of gradient values used in the first or plurality of feature regions. The display control unit controls a display to display the first image and the second image, and indicate the attention region.

### BACKGROUND

### Technical Field

One disclosed aspect of the embodiments relates to a display control device, a display device, and a display control method.

### Description of the Related Art

In recent years, in the field of video production, there are opportunities for handling images having a broader dynamic range than the conventional standard dynamic range (SDR). This broad dynamic range is referred to as high dynamic range (HDR). Also, in video production, simultaneous production is sometimes performed, in which image contents of the same contents are produced in both HDR and SDR.

Japanese Patent Application Publication No. 2020-145553 describes technology for presenting users with pixels of a brightness range in which gradation drops when images in HDR (HDR images) are converted into images in SDR (SDR images) (e.g., pixels with a gradient value of at least 150 in an HDR image). Gradation here is a breadth of gradients to express one brightness range.

Meanwhile, there is a possibility that difference in image quality (difference in appearance) may be small between HDR images and SDR images, even in ranges made up of pixels of a brightness range in which gradation drops, due to the number of pixels of this brightness range in this region being small, and so forth. Accordingly, there are cases in which users cannot comprehend regions with great difference in image quality between HDR images and SDR images, even when using the technology according to Japanese Patent Application Publication No. 2020-145553.

### SUMMARY

An aspect of the disclosure is a display control device including at least one memory and at least one processor which function as an acquiring unit, a selecting unit, and a display control unit. The acquiring unit is configured to acquire a first image that is an image having a first dynamic range, and a second image that is an image having a second dynamic range that is narrower than the first dynamic range, and is an image representing content that is same as content represented by the first image. The selecting unit is configured to select, in a case where the first image and the second image include one or a plurality of feature regions, at least one of the one or plurality of feature regions as an attention region, on a basis of a count of gradient values used in each of the one or plurality of feature regions. The display control unit configured to control a display to 1) display the first image and the second image, and 2) indicate the attention region.

An aspect of the disclosure is a display control device including at least one memory and at least one processor which function as an acquiring unit, a selecting unit, and a display control unit. The acquiring unit is configured to acquire a first image that is an image having a first dynamic range, and a second image that is an image having a second dynamic range that is narrower than the first dynamic range, and is an image representing content that is same as content represented by the first image. The selecting unit is configured to select, in a case where the first image and the second image include one or a plurality of feature regions, at least one of the one or plurality of feature regions as an attention region, on a basis of a display brightness of each of the one or plurality of feature regions in the first image and a display brightness of each of the one or plurality of feature regions in the second image. The display control unit is configured to control a display to 1) display the first image and the second image, and 2) indicate the attention region.

An aspect of the disclosure is a display control method including acts of acquiring, selecting, and controlling. The act of acquiring acquires a first image that is an image having a first dynamic range, and a second image that is an image having a second dynamic range that is narrower than the first dynamic range, and is an image representing content that is same as content represented by the first image. The act of selecting selects, in a case where the first image and the second image include one or a plurality of feature regions, at least one of the one or plurality of feature regions as an attention region, on a basis of a count of gradient values of pixels used in each of the one or plurality of feature regions. The act of controlling controls a display to display the first image and the second image, and to indicate the attention region.

An aspect of the disclosure is a display control method including acts of acquiring, selecting, and controlling. The act of acquiring acquires a first image that is an image having a first dynamic range, and a second image that is an image having a second dynamic range that is narrower than the first dynamic range, and is an image representing content that is same as content represented by the first image. The act of selecting selects, in a case where the first image and the second image include one or a plurality of feature regions, at least one of the one or plurality of feature regions as an attention region, on a basis of a display brightness of each of the one or plurality of feature regions in the first image and a display brightness of each of the one or plurality of feature regions in the second image. The act of controlling controls a display to display the first image and the second image, and to indicate the attention region.

Further features of the disclosure will become apparent from the following description of exemplary embodiments with reference to the attached drawings.

### BRIEF DESCRIPTION OF THE DRAWINGS

FIG. 1 is a configuration diagram of a display device according to a first embodiment.

FIG. 2 is a flowchart of attention display processing according to the first embodiment.

FIG. 3A is a diagram illustrating an HDR image according to the first embodiment, and FIG. 3B is a diagram illustrating a feature region according to the first embodiment.

FIGS. 4A to 4C are diagrams showing brightness histograms of a high-brightness region according to the first embodiment.

FIGS. 5A and 5B are diagrams showing brightness histograms of a high-brightness region according to the first embodiment.

FIGS. 6A and 6B are diagrams showing brightness histograms of a low-brightness region according to the first embodiment.

FIGS. 7A and 7B are diagrams showing brightness histograms of a low-brightness region according to the first embodiment.

FIGS. 8A and 8B are diagrams showing chromatic histograms of a high-chroma region according to the first embodiment.

FIG. 9 is a diagram illustrating an attention region according to the first embodiment.

FIG. 10 is a diagram illustrating a display image according to the first embodiment.

FIG. 11 is a relational diagram of display brightness between an HDR image and an SDR image according to the first embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU) or a programmable circuit, or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials. High dynamic range (HDR) formats include perceptual quantizer (PQ) and hybrid log-gamma (HLG) stipulated in the Radiocommunications Sector of ITU (ITU-R) BT.2100. The PQ format is a standard that can handle brightness up to 10,000 cd/m² maximum.

There also is difference in color space between HDR and standard dynamic range (SDR), not just difference in dynamic range of brightness. Color space is often expressed by BT.709 in SDR. In HDR, color space is often expressed by BT.2020, which is broader than BT.709. Hereinafter, color space in HDR will be BT.2020, and color space in SDR will be BT.709.

The expressible dynamic ranges differ between HDR and SDR. Accordingly, the difference in image quality between HDR images and SDR images is markedly pronounced in bright regions (particularly in regions representing the sun, reflecting metals, and so forth), and dark regions (regions such as shadows and so forth). For example, when converting HDR images into SDR images, the brightness range in bright regions particular to HDR are compressed to a narrow range around 100 cd/m² in SDR images.

In a case in which there are a plurality of pixels of which gradient values are each 240 to 255 (8-bit notation) in a bright region of an HDR image, for example, assumption will be made that all of the gradient values of 240 to 255 are converted to a gradient value of 255 when converting from the HDR image to an SDR image. This means that in the SDR image, the number of gradients in this bright region (the number of gradient values used in the bright region) is one. In this case, the number of gradients expressing the bright region in the HDR image is reduced from 16 to one by conversion from the HDR image to the SDR image, and accordingly the image quality deteriorates.

Thus, regions in which the number of gradients is greatly reduced between HDR images and SDR images are regions that should be given more attention, as compared to regions in which the number of gradients is not reduced.

Also, the color spaces differ between HDR and SDR, as described above. Accordingly, between HDR images and SDR images, the high-chroma regions in HDR images in particular are subjected to compressed chroma in conversion to SDR images, due to the difference in color space. Accordingly, regions in which the number of gradients of chroma is greatly reduced between HDR images and SDR images are also regions that should be given more attention for confirmation of image quality difference between HDR images and SDR images (hereinafter referred to as “attention regions”), as compared to regions in which the number of gradients of chroma is not reduced.

### First Embodiment

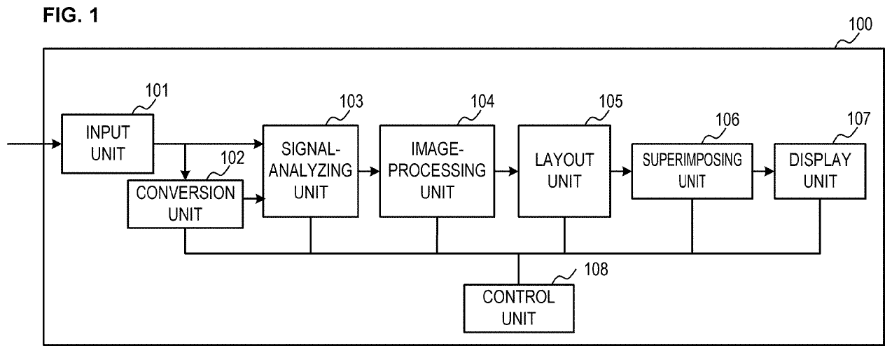

A display device 100 according to a first embodiment that shows attention regions to users will be described below. FIG. 1 is a configuration diagram of the display device 100. The display device 100 includes an input unit or circuit 101, a conversion unit or circuit 102, a signal-analyzing unit or circuit 103, an image-processing unit or circuit 104, a layout unit or circuit 105, a superimposing unit or circuit 106, a display unit or circuit 107, and a control unit or circuit 108.

The input unit 101 receives image signals from an external device (image-capturing device, player device, etc.), and outputs the received image signals to the conversion unit 102 and the signal-analyzing unit 103. The input unit 101 has an input terminal conforming to a standard such as serial digital interface (SDI), High-Definition Multimedia Interface (HDMI) (registered trademark), or the like, for example. Note that in the first embodiment, description will be made assuming that image signals in HDR (HDR signals) have been input to the input unit 101.

The conversion unit 102 executes processing of converting the HDR signals input from the input unit 101 into image signals in SDR (SDR signals) (processing of converting HDR into SDR that has a narrower dynamic range than HDR). The conversion unit 102 outputs the SDR signals following conversion processing to the signal-analyzing unit 103.

The signal-analyzing unit 103 analyzes a frame image in HDR signals (hereinafter referred to as “HDR image”) input from the input unit 101 and a frame image in SDR signals (hereinafter referred to as “SDR image”) input from the conversion unit 102. Note that the HDR image and the SDR image are images of the same content. Also, the signal-analyzing unit 103 outputs the HDR image and the SDR image to the image-processing unit 104, and also outputs analysis results to the control unit 108. The analysis results here are data indicating a histogram of feature regions (high-brightness regions, low-brightness regions, and high-chroma regions).

The image-processing unit 104 subjects the images (SDR image and HDR image) to image processing in accordance with the Electro-Optical Transfer Function (EOTF) type (PQ, HLG, Gamma 2.2, etc.) and the color gamut type (ITU-R BT.709, ITU-R BT.2020, etc.). The image-processing unit 104 outputs the images following image processing to the layout unit 105.

The layout unit 105 arranges (lays out) the SDR image and the HDR image acquired from the image-processing unit 104 upon one image, and performs output thereof to the superimposing unit 106.

The superimposing unit 106 superimposes a display item (rectangular frame, etc.) showing an attention region (region in which image quality difference is great between the HDR image and the SDR image) on the image acquired from the layout unit 105. The superimposing unit 106 outputs the image following superimposing processing of the display item to the display unit 107 as a display image.

The display unit 107 is, for example, a display including a backlight and a liquid crystal panel. The display unit 107 displays the display image acquired from the superimposing unit 106 on a display screen.

The control unit 108 controls the components following programs stored in non-volatile memory or the like, on the basis of settings (image quality settings, comparison display settings, attention settings, etc.) made in accordance with user operations. The image quality settings are settings such as EOTF settings, color gamut settings, and so forth.

Comparison display settings indicate whether or not to set to a comparison display mode in which the HDR image and the SDR image are displayed side by side (in two screens). When the comparison display settings are set to on (the comparison display mode is set), the control unit 108 controls the conversion unit 102 to convert the HDR image into the SDR image. Thereafter, the control unit 108 controls the image-processing unit 104 to subject each of the HDR image and the SDR image to image processing (processing in accordance with EOTF type and color gamut type). Further, the control unit 108 controls the layout unit 105 and the superimposing unit 106 to display a display image in which the HDR image and the SDR image are side by side, on the display unit 107.

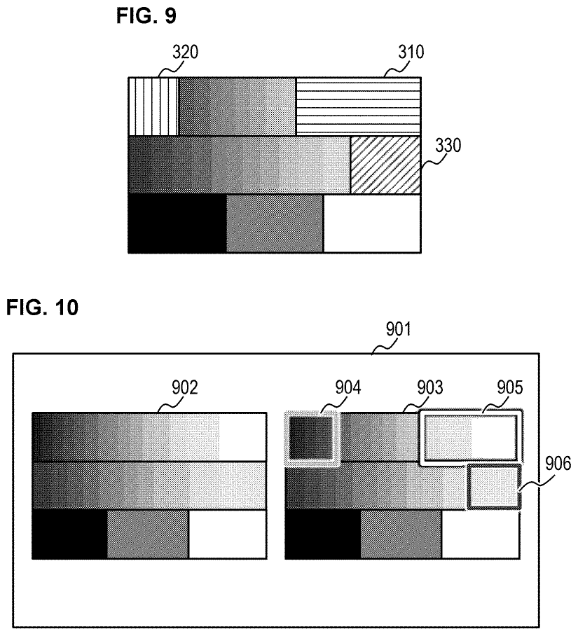

Attention settings are settings that indicate whether or not to display the display item showing the attention region (to present the attention region) in the comparison display mode (see FIG. 10). When the attention settings are set to on, the control unit 108 controls the signal-analyzing unit 103 to analyze the HDR image and the SDR image, and acquires analysis results. The control unit 108 then selects an attention region on the basis of the analysis results, and controls the superimposing unit 106 to superimpose the display item showing the attention region on the HDR image or the SDR image.

Note that a display control device that has the components of the display device 100 other than the display unit 107 may be used, instead of the display device 100. The display control device may also realize displaying the HDR image and the SDR image side by side while showing the attention region, by controlling display of an external display device. Accordingly, optional electronic equipment (information processing device) such as a digital camera, a smartphone, or the like, may be used instead of the display device 100 according to the first embodiment, as long as display of a display unit (display device) can be controlled.

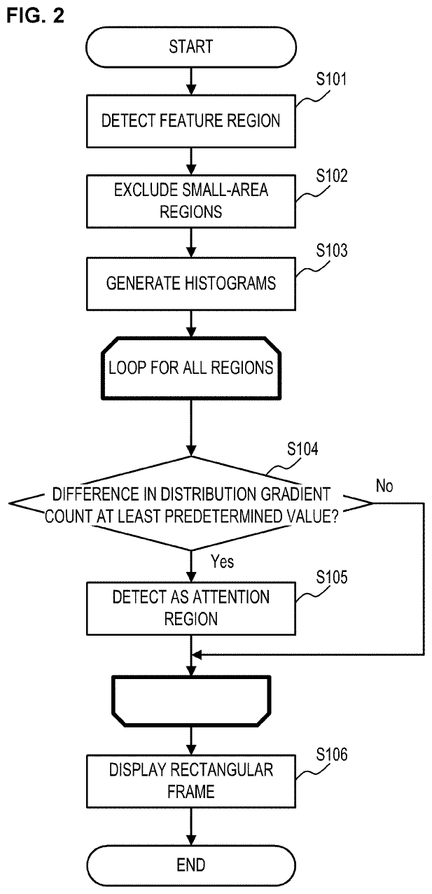

(Attention Display Processing) Details of attention display processing (display control method) for displaying the display item showing the attention region (presenting the attention region) will be described with reference to the flowchart in FIG. 2. The attention display processing shown in FIG. 2 is periodically (e.g., once a second) started in a case where the attention settings are set to on in the comparison display mode. Note that each step of the processing in this flowchart is realized by the control unit 108 executing a program and controlling the components.

(Step S101) In step S101, the control unit 108 controls the signal-analyzing unit 103 to detect feature regions (high-brightness regions, low-brightness regions, and high-chroma regions) in the HDR image acquired from the input unit 101. Note that the control unit 108 may detect feature regions from the SDR image instead of the HDR image.

In detection of high-brightness regions, the signal-analyzing unit 103 converts the RGB value of each pixel in the HDR image into a YCbCr value, and detects pixels in which the Y value (gradient value indicating display brightness) is at least a predetermined value as being a high-brightness pixel. The predetermined value is, for example, Y value=130 (equivalent to 100 cd/m² in the PQ format). The signal-analyzing unit 103 then detects a plurality of the high-brightness pixels that are adjacent as one high-brightness region.

In detection of low-brightness regions, the signal-analyzing unit 103 detects, out of pixels in the HDR image, pixels of which the Y value is not more than a predetermined value, as being low-brightness pixels. The predetermined value is, for example, Y value=38 (equivalent to 1 cd/m² in the PQ format). The signal-analyzing unit 103 then detects a plurality of the low-brightness pixels that are adjacent as one low-brightness region.

In detection of high-chroma regions, the signal-analyzing unit 103 converts the RGB value of each pixel in the HDR image into an HLS color space value, and calculates the converted S value as a gradient value indicating chroma. The signal-analyzing unit 103 detects pixels in which the calculated S value is at least a predetermined value (e.g., pixels of which the S value is at least 100) as being a high-chroma pixel. The signal-analyzing unit 103 then detects a plurality of the high-chroma pixels that are adjacent as one high-chroma region.

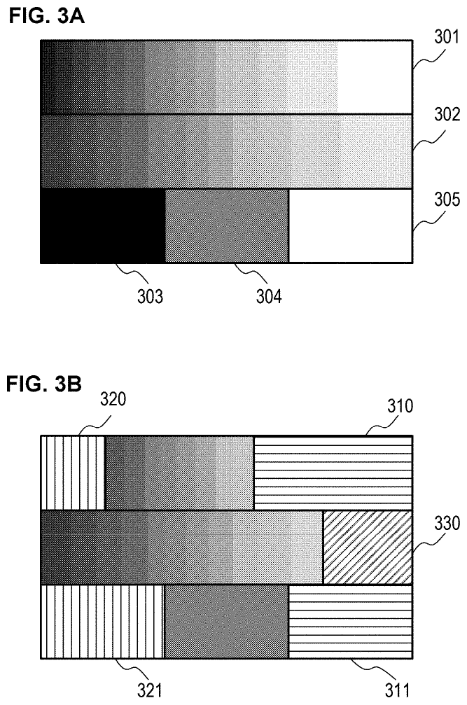

FIGS. 3A and 3B illustrate the HDR image, and an example of results of the signal-analyzing unit 103 detecting feature regions (high-brightness regions, low-brightness regions, and high-chroma regions) in the HDR image.

FIG. 3A illustrates an example of the HDR image. The HDR image is made up of a grayscale gradient region 301, a red gradient region 302, a black region 303, a gray region 304, and a white region 305. The grayscale gradient region 301 is a region that is lighter the farther toward the right end of the image. The red gradient region 302 is a red region in which the chroma is higher the farther toward the right end of the image. The black region 303 is a region in which all pixels are Y value=0. The gray region 304 is a region in which all pixels are Y value=100. The white region 305 is a region in which all pixels are Y value=255.

FIG. 3B is an example of results of the signal-analyzing unit 103 detecting feature regions (high-brightness regions, low-brightness regions, and high-chroma regions) in the HDR image illustrated in FIG. 3A. In FIG. 3B, the regions detected as being high-brightness regions are the regions indicated by lateral lines (high-brightness region 310 and high-brightness region 311). The regions detected as being low-brightness regions are the regions indicated by vertical lines (low-brightness region 320 and low-brightness region 321). The region detected as a high-chroma region is the region indicated by hatching (high-chroma region 330). Regions other than these are not detected as being feature regions. Note that according to the above method, there is a possibility that the range of high-brightness regions and the range of high-chroma regions will be detected overlapping, depending on the HDR image, and such detection is acceptable.

(Step S102) In step S102, the control unit 108 controls the signal-analyzing unit 103 to remove, out of the feature regions (high-brightness regions, low-brightness regions, and high-chroma regions) detected in step S101, feature regions that are small in area (small-area regions). That is to say, the signal-analyzing unit 103 excludes regions out of the detected feature regions of which a pixel count (pixel count of high-brightness pixels, low-brightness pixels, and high-chroma pixels) is smaller than a threshold value.

The threshold value used in step S102 may be a predetermined value such as 100 or the like, or may be a value in accordance with a total pixel count of the HDR image. For example, in a case where the total pixel count of the HDR image is 1920×1080, the signal-analyzing unit 103 sets the threshold value to 100. Conversely, in a case where the total pixel count of the HDR image is 3840×2160, the signal-analyzing unit 103 sets the threshold value to 400 (100 multiplied by 4), since the total pixel count of the HDR image is fourfold that of the case in which total pixel count of the HDR image is 1920×1080.

(Step S103) In step S103, the control unit 108 controls the signal-analyzing unit 103 to generate a histogram for the HDR image (image acquired from the input unit 101) and the SDR image (image acquired from the conversion unit 102). More specifically, the signal-analyzing unit 103 generates a brightness histogram of high-brightness regions and low-brightness regions, and a chroma histogram of high-chroma regions.

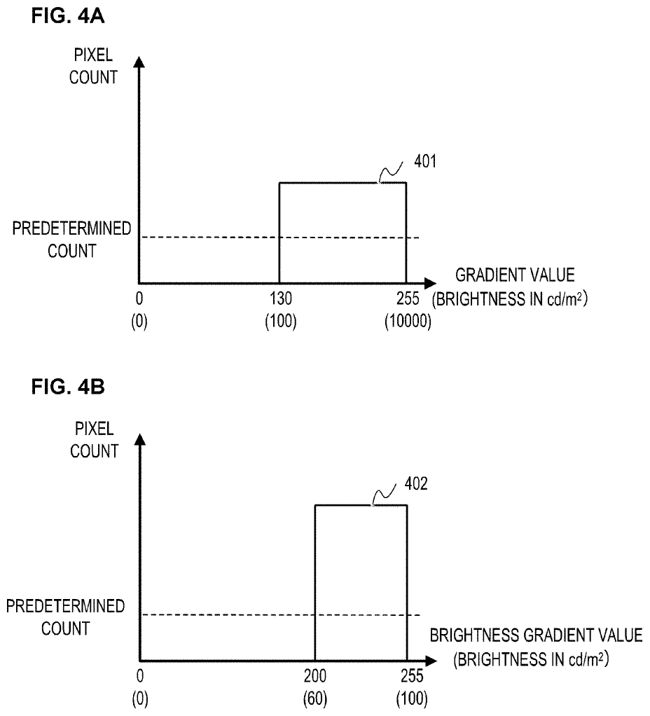

FIGS. 4A to 8B show examples of brightness histograms (brightness histograms of high-brightness regions and low-brightness regions in the HDR image and the SDR image) and chroma histograms (chroma histograms of high-chroma regions) generated by the signal-analyzing unit 103. Now, a brightness histogram is a graph indicating a pixel count for each brightness gradient value (Y value in YCbCr). In a brightness histogram, the horizontal axis represents the brightness gradient value, and the vertical axis represents the pixel count. Also, a chroma histogram is a graph that shows a pixel count at each chroma (S value in HLS color space). In a chroma histogram, the horizontal axis represents the chroma, and the vertical axis represents the pixel count.

FIG. 4A is a diagram showing a brightness histogram 401 of the high-brightness region 310 in the HDR image. Also, FIG. 4B is a diagram showing a brightness histogram 402 of the high-brightness region 310 in the SDR image.

According to the brightness histogram 401, it can be understood that in the high-brightness region 310 in the HDR image, there is a distribution of pixels of which the Y value is 130 to 255. According to the brightness histogram 402, it can be understood that in the high-brightness region in the SDR image, there is a distribution of pixels of which the Y value is 200 to 255. Now, the expression “there is a distribution of pixels” means that “the count of pixels of the same gradient value is at least a predetermined count (10 in the first embodiment)”. That is to say, the expression “there is a distribution of pixels of which the Y value is 200” means that “the count of pixels of which the Y value is 200 is at least the predetermined count”. Accordingly, in the region indicated by the brightness histogram 403 in FIG. 4C, while pixels of which the Y value is 130 to 134 do exist, there only is a distribution of pixels of which the Y value is 135 to 200 and 210 to 255.

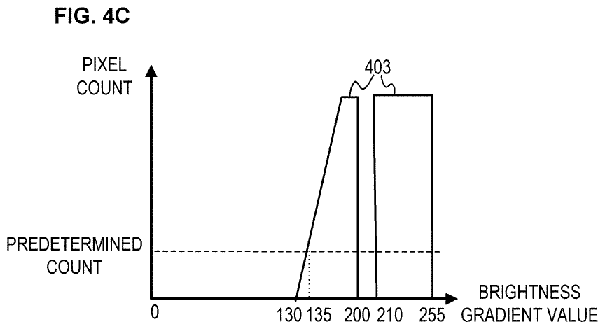

FIG. 5A is a diagram showing a brightness histogram 501 of the high-brightness region 311 in the HDR image. FIG. 5B is a diagram showing a brightness histogram 502 of the high-brightness region 311 in the SDR image. According to the brightness histogram 501 and the brightness histogram 502, it can be understood that in both the HDR image and the SDR image, only pixels of which the Y value is 255 are distributed in the high-brightness region 311.

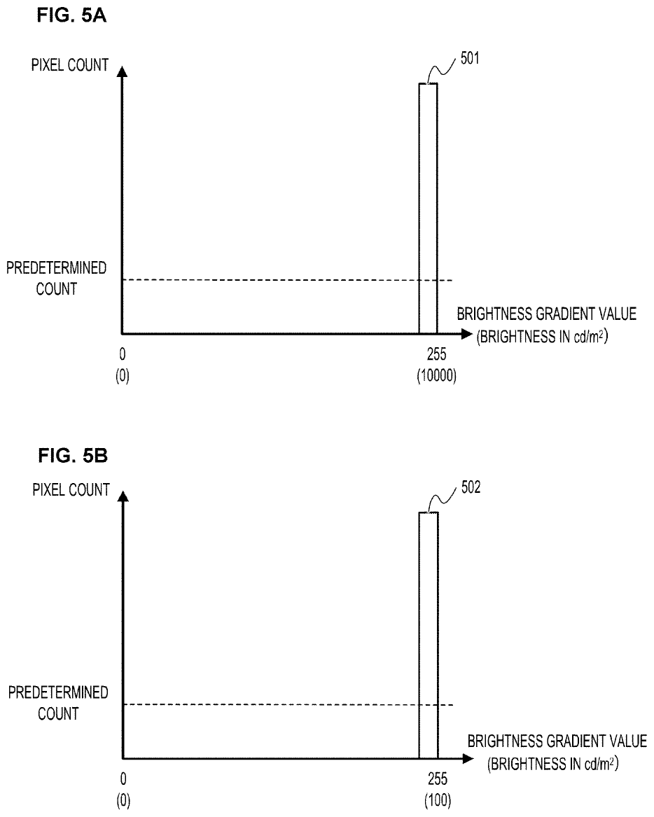

FIG. 6A is a diagram showing a brightness histogram 601 of the low-brightness region 320 in the HDR image. FIG. 6B is a diagram showing a brightness histogram 602 of the low-brightness region 320 in the SDR image. According to the brightness histogram 601, it can be understood that there is a distribution of pixels of which the Y value is 0 to 38 in the low-brightness region 320 of the HDR image. According to the brightness histogram 602, it can be understood that there is a distribution of pixels of which the Y value is 0 to 50 in the low-brightness region 320 of the SDR image.

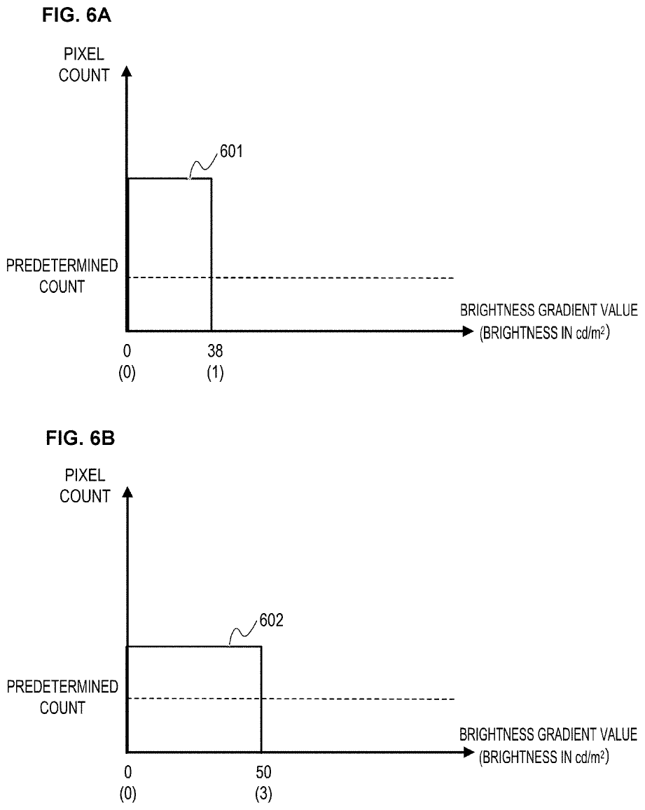

FIG. 7A is a diagram showing a brightness histogram 701 of the low-brightness region 321 in the HDR image. Also, FIG. 7B is a diagram showing a brightness histogram 702 of the low-brightness region 321 in the SDR image. According to the brightness histogram 701 and the brightness histogram 702, it can be understood that in both the HDR image and the SDR image, only pixels of which the Y value is 0 are distributed in the low-brightness region 321.

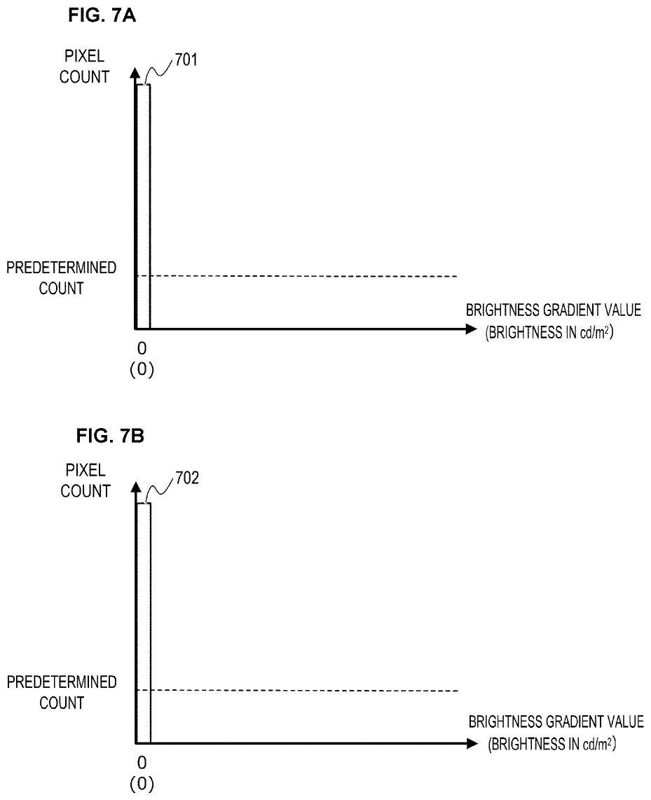

FIG. 8A is a diagram showing a chroma histogram 801 of the high-chroma region 330 in the HDR image. Also, FIG. 8B is a diagram showing a chroma histogram 802 of the high-chroma region 330 in the SDR image. According to the chroma histogram 801, it can be understood that pixels of which the S value is 150 to 255 are distributed in the high-chroma region 330 in the HDR image. According to the chroma histogram 802, it can be understood that pixels of which the S value is 180 to 255 are distributed in the high-chroma region 330 in the SDR image.

Hereinafter, the processing in steps S104 and S105 is individually executed for each of the feature regions detected in step S101. Feature regions that are the object of the processing of steps S104 and S105 will be referred to as “object regions” below.

(Step S104) In step S104, the control unit 108 determines whether or not the difference between the distribution gradient count in an object region in the HDR image and the distribution gradient count in the object region in the SDR image is at least a predetermined threshold value. Note that the distribution gradient count here is the gradient count (count of gradient values) used (to be used) in the object region. In the first embodiment, the predetermined threshold value is 10. However, the predetermined threshold value may be 5, 20, or other values. Whether or not the difference between the distribution gradient counts in the object region in these two images is at least the predetermined threshold value is determined on the basis of the histograms generated in step S103. In a case in which the difference between the distribution gradient counts in the object region in these two images is at least the predetermined threshold value, the flow advances to step S105. In a case in which the difference between the distribution gradient counts in the object region in these two images is below the predetermined threshold value, the processing of steps S104 and S105 for this object region ends.

With regard to the high-brightness region 310, according to the brightness histogram 401, the Y value of pixels distributed in the HDR image is 130 to 255, and accordingly the distribution gradient count is 126 (i.e., 255−130+1). Also, according to the brightness histogram 402, the distribution gradient count in the SDR image is 56 (i.e., 255−200+1). Accordingly, the difference in distribution gradient counts between the HDR image and the SDR image is 70 regarding the high-brightness region 310, which is at least the predetermined threshold value (at least 10). Note that for a region indicated by the brightness histogram 403 in FIG. 4C, for example, the Y value of the pixels that are distributed is 135 to 200 and 210 to 255, and accordingly the distribution gradient count is 66+46=112.

With regard to the high-brightness region 311, according to the brightness histogram 501, the distribution gradient count in the HDR image is 1. Meanwhile, according to the brightness histogram 502, the distribution gradient count in the SDR image is also 1. Accordingly, the difference in distribution gradient counts between the HDR image and the SDR image regarding the high-brightness region 311 is 0, which is below the predetermined threshold value.

With regard to the low-brightness region 320, according to the brightness histogram 601, the distribution gradient count is 39 (i.e., 38−0+1) in the HDR image. Meanwhile, according to the brightness histogram 602, the distribution gradient count is 51 (i.e., 50−0+1) in the SDR image. Accordingly, with regard to the low-brightness region 320, the difference in distribution gradient counts between the HDR image and the SDR image is 12, which is at least the predetermined threshold value.

With regard to the low-brightness region 321, according to the brightness histogram 701, the distribution gradient count in the HDR image is 1. Meanwhile, according to the brightness histogram 702, the distribution gradient count in the SDR image is also 1. Accordingly, the difference in distribution gradient counts between the HDR image and the SDR image regarding the low-brightness region 321 is 0, which is below the predetermined threshold value.

With regard to the high-chroma region 330, according to the chroma histogram 801, the distribution gradient count is 106 (i.e., 255−150+1) in the HDR image. Meanwhile, according to the chroma histogram 802, the distribution gradient count in the SDR image is 76 (i.e., 255−180+1). Accordingly, the difference in distribution gradient counts between the HDR image and the SDR image is 30 for the high-chroma region 330, which is at least the predetermined threshold value.

(Step S105) In step S105, the control unit 108 selects an object region as an attention region.

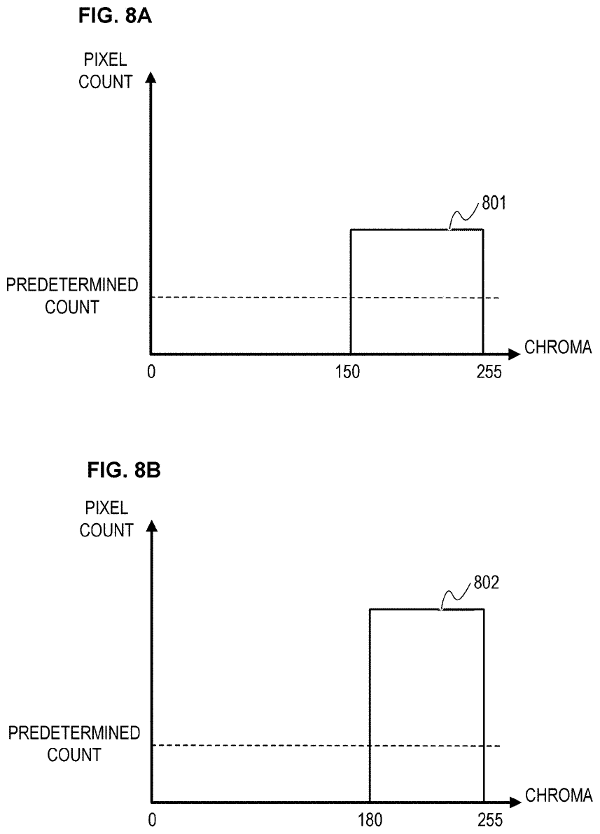

In a case in which the processing of steps S104 and S105 has ended for all feature regions, the flow advances to step S106. Note that when the processing of steps S104 and S105 is executed in the HDR image illustrated in FIG. 3A for example, the three feature regions of the high-brightness region 310, the low-brightness region 320, and the high-chroma region 330 are selected as attention regions, as illustrated in FIG. 9.

(Step S106) In step S106, the control unit 108 controls the superimposing unit 106 to superimpose a display item (rectangular frame) showing an attention region on the HDR image or the SDR image. The control unit 108 then displays the image obtained by superimposing the display item showing the attention regions on the HDR image or the SDR image (display image) on the display unit 107.

FIG. 10 is a diagram illustrating an example of the display image displayed on the display unit 107 after the processing of step S106 ends. In FIG. 10, an HDR image 902 and an SDR image 903 (the SDR image obtained by conversion of the HDR image 902 by the conversion unit 102) are displayed in a display screen 901 of the display unit 107. Also, the layout unit 105 has the HDR image 902 arranged to the left screen in the display screen 901, and the SDR image 903 arranged to the right screen in the display screen 901.

In the SDR image 903, a rectangular frame (rectangular display item) showing an attention region 904 of a low-brightness region, a rectangular frame showing an attention region 905 of a high-brightness region, and a rectangular frame showing an attention region 906 of a high-chroma region, are displayed.

The rectangular frames showing the attention regions show attention regions of low-brightness regions using green frames, show attention regions of high-brightness regions using red frames, and show attention regions of high-chroma regions using blue frames. Thus, the display device 100 performs display in different colors in accordance with the types of the attention regions (whether an attention region of a low-brightness region, an attention region of a high-brightness region, or an attention region of a high-chroma region). Accordingly, the user can recognize the type of the attention region displayed by checking the color. Note that the shape of the frame, the heaviness of the lines of the frame, and so forth, may be differentiated in accordance with the type of the attention region, besides the color. That is to say, the form of presenting the attention region (the display form of the frame) may be differentiated in accordance with the type of the attention region.

As described above, the display device 100 displays the HDR image and the SDR image, and also displays a rectangular frame or the like to present attention regions in which the difference in image quality is great between the HDR image and the SDR image to the user. Accordingly, the user can readily recognize attention regions.

Note that description has been made that in step S104, the control unit 108 determines an attention region in accordance with whether or not the difference in distribution gradient count of an object region in the HDR image and the SDR image is at least a predetermined threshold value. However, the control unit 108 may determine an attention region in accordance with whether or not a ratio of “distribution gradient count of object region of SDR image” as to “distribution gradient count of object region of HDR image” is not more than a predetermined threshold value. For example, in the example of high-brightness region 310, the distribution gradient count in the HDR image is 126, and the distribution gradient count in the SDR image is 56. Also, the predetermined threshold value is set to 0.5. Thus, the ratio of the distribution gradient count of the SDR image as to the distribution gradient count of the HDR image is 56/126, which is approximately equal to 0.444, which is not more than the predetermined threshold value. Accordingly, the high-brightness region 310 is selected as an attention region.

Also, although an example of displaying attention regions by rectangle frames in step S106 has been described, this is not limiting, and attention regions may be shown by filling in the attention regions or displaying the attention regions in a zebra display (represented by stripes), for example. That is to say, any type of display may be made as long as it is a display that presents attention regions so that the user can comprehend the attention regions. Further, the control unit 108 may, for example, display the frame for attention regions that are high-brightness regions, fill in attention regions that are low-brightness regions, and perform a zebra display of attention regions that are high-chroma regions. Also, an example has been described in which the rectangle frame showing attention regions is superimposed on the SDR image 903. However, the rectangle frame may be superimposed on the HDR image 902, or an arrangement may be made in which the user can select which of the HDR image 902 and the SDR image 903 to superimpose upon.

Although an example of the display device 100 converting an HDR image into an SDR image has been described in the first embodiment, the display device 100 may acquire an SDR image of the same content as an HDR image from a separate device. That is to say, the display device 100 may have two input units, with input HDR images (HDR signals) and SDR images (SDR signals) being input to the input units, respectively. In this case, the HDR images and the SDR images input to the display device 100 are directly input to the signal-analyzing unit 103. In other words, any configuration may be made as long as a configuration in which both HDR images and SDR images can be acquired with the signal-analyzing unit 103 as an image acquiring unit. For example, the conversion unit 102 may generate an HDR image and an SDR image from a single image, and output the two generated images to the signal-analyzing unit 103.

First Modification

In the first embodiment, in step S104, the control unit 108 selects attention regions on the basis of difference between the distribution gradient count of the HDR image and the distribution gradient count of the SDR image. However, with regard to high-brightness regions, the control unit 108 may select high-brightness regions of which the distribution gradient count of the HDR image is at least a predetermined threshold value as attention regions. That is to say, attention regions may be selected simply on the basis of the distribution gradient count of the HDR image, without performing calculation processing of the distribution gradient count of the SDR image. This takes advantage of the fact that in high-brightness regions, the distribution gradient count often drops in many cases when HDR images are converted into SDR images.

Second Modification

In the first embodiment, in step S104, the control unit 108 selects attention regions on the basis of difference between the distribution gradient count of the HDR image and the distribution gradient count of the SDR image. However, the control unit 108 may select attention regions on the basis of difference in display brightness (in units of cd/m²) obtained by converting gradient values on the basis of EOTF settings.

Specifically, in step S104, the control unit 108 calculates the display brightness in which the Y value of each pixel in object regions has been converted, for each of the HDR images and the SDR images. Thereafter, the control unit 108 calculates the average display brightness (average value of display brightness) by averaging the calculated display brightness of the pixels in an object region, for each of the HDR images and the SDR images. The control unit 108 then, in a case where the difference between the average display brightness of the object region in the HDR image and the average display brightness of the object region in the SDR image is at least a predetermined threshold value (Yes in step S104), selects the object region as an attention region in step S105.

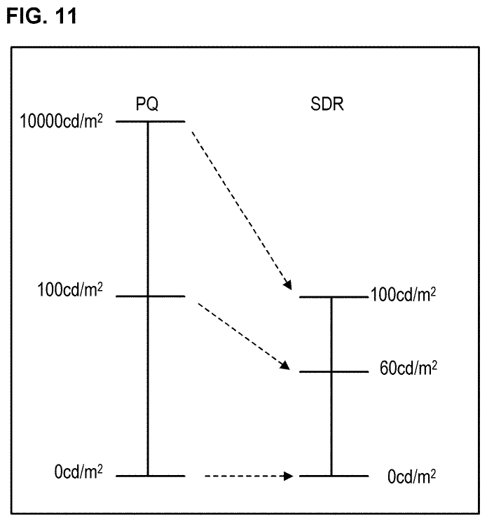

FIG. 11 is a diagram showing an example of a correlative relation between display brightness of an HDR image (display brightness expressed by PQ format) and display brightness of an SDR image (display brightness in a case of converting the display brightness of the HDR image into SDR). The display brightness 10,000 cd/m² in the HDR image is converted into display brightness of 100 cd/m² in the SDR image. Accordingly, the difference in display brightness generated due to converting the HDR image into the SDR image is 9,900 cd/m². Also, the display brightness 100 cd/m² in the HDR image is converted into display brightness of 60 cd/m² in the SDR image. Accordingly, the difference in display brightness generated due to converting the HDR image into the SDR image is 40 cd/m².

In this way, the difference in display brightness in feature regions in the HDR image and the SDR image varies greatly depending on the display brightness of this feature region in the HDR image (e.g., the gradient value and the EOTF). Accordingly, there are cases in which the image quality difference can be detected more appropriately by selecting the attention region on the basis of difference in display brightness of feature regions among HDR images and SDR images, rather than selecting on the basis of difference in gradient values of feature regions among HDR images and SDR images.

Also, the control unit 108 may select attention regions on the basis of difference in contrast, difference in highest display brightness (highest value of display pixel values), or difference in total display brightness, in feature regions among HDR images and SDR images. That is to say, the control unit 108 may select feature regions in which these differences are at least a predetermined threshold value, as attention regions. Also, attention regions may be selected on the basis of “ratio” rather than “difference”. For example, the control unit 108 selects feature regions in which the ratio of the highest display brightness in the SDR image as to the highest display brightness of the HDR image is not more than a predetermined threshold value as attention regions.

Now, the contrast in a certain region is a value obtained by dividing the highest display brightness by the lowest display brightness in this region. The total display brightness of a certain region is the total value of display brightness of all pixels in this region.

According to the disclosure, regions in which difference in image quality is great among two images of the same content with different dynamic ranges can be shown to the user.

Also, in the above, “in a case where A is at least B, the flow advances to step S1, and in a case where A is below (lower than) B, the flow advances to step S2” may be reread as “in a case where A greater (higher) than B, the flow advances to step S1, and in a case where A is not more than B, the flow advances to step S2”. Conversely, “in a case where A greater (higher) than B, the flow advances to step S1, and in a case where A is not more than B, the flow advances to step S2” may be reread as “in a case where A is at least B, the flow advances to step S1, and in a case where A is below (lower than) B, the flow advances to step S2”. Accordingly, the expression “at least A” may be substituted with “A or greater (higher, longer, more) than A”, and may be reread as “greater (higher, longer, more) than A” and substituted. Conversely, the expression “not more than A” may be substituted with “A or smaller (lower, shorter, less) than A”, and may be substituted with “smaller (lower, shorter, less) than A” and reread. Also, “greater (higher, longer, more) than A” may be reread as “at least A”, and “smaller (lower, shorter, less) than A” may be reread as “not more than A”.

Although the disclosure has been described in detail by way of preferred embodiments, the disclosure is not limited to these particular embodiments, and various forms made without departing from the spirit and scope of the disclosure are encompassed by the disclosure. Part of the above-described embodiments may be combined as appropriate.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-011842, filed on Jan. 28, 2022, which is hereby incorporated by reference herein in its entirety.

What is claimed is:

1. A display control device comprising at least one memory and at least one processor which function as:
an acquiring unit configured to acquire
a first image that is an image having a first dynamic range, and
a second image that is an image having a second dynamic range that is narrower than the first dynamic range, and is an image representing content that is same as content represented by the first image;
a selecting unit configured to select, in a case where the first image and the second image include one or a plurality of feature regions, at least one of the one or plurality of feature regions as an attention region, on a basis of a count of gradient values used in each of the one or plurality of feature regions; and
a display control unit configured to control a display to 1) display the first image and the second image, and 2) indicate the attention region.

2. The display control device according to claim 1, wherein
the one or plurality of feature regions include at least one of a first feature region, a second feature region, and a third feature region,
the first feature region is a region of a plurality of pixels of which a gradient value indicating a display brightness in the first image is greater than a first predetermined value,
the second feature region is a region of a plurality of pixels of which a gradient value indicating a display brightness in the first image is smaller than a second predetermined value, and
the third feature region is a region of a plurality of pixels of which a gradient value indicating chroma in the first image is greater than a third predetermined value.

3. The display control device according to claim 2, wherein
the display control unit varies a form of indicating the attention region in accordance with which of the first feature region, the second feature region, and the third feature region that the attention region is.

4. The display control device according to claim 2, wherein
the one or plurality of feature regions includes one or a plurality of the first feature region,
the selecting unit selects, out of the one or plurality of first feature regions, a first feature region of which a distribution gradient count in the first image is greater than a threshold value, as the attention region, and
the distribution gradient count is a count of gradient values regarding which a count of pixels in a feature region is greater than a predetermined count.

5. The display control device according to claim 1, wherein
the selecting unit selects the attention region from the one or plurality of feature regions on a basis of a count of gradient values used in each feature region of the first image and a count of gradient values used in each feature region of the second image.

6. The display control device according to claim 5, wherein
the selecting unit selects, from the one or plurality of feature regions, a feature region of which a difference between a distribution gradient count in the first image and a distribution gradient count in the second image is greater than a threshold value, as the attention region, and
the distribution gradient count is a count of gradient values regarding which a count of pixels in a feature region is greater than a predetermined count.

7. A display control device comprising at least one memory and at least one processor which function as:
an acquiring unit configured to acquire
a first image that is an image having a first dynamic range, and
a second image that is an image having a second dynamic range that is narrower than the first dynamic range, and is an image representing content that is same as content represented by the first image;
a selecting unit configured to select, in a case where the first image and the second image include one or a plurality of feature regions, at least one of the one or plurality of feature regions as an attention region, on a basis of a display brightness of each of the one or plurality of feature regions in the first image and a display brightness of each of the one or plurality of feature regions in the second image; and
a display control unit configured to control a display to 1) display the first image and the second image, and 2) indicate the attention region.

8. The display control device according to claim 7, wherein
the selecting unit selects a feature region in which a difference between an average value of display brightness in the first image and an average value of display brightness in the second image is greater than a threshold value, as the attention region.

9. The display control device according to claim 7, wherein
the selecting unit selects a feature region in which a difference between a total of display brightness of all pixels in the first image and a total of display brightness of all pixels in the second image is greater than a threshold value, as the attention region.

10. The display control device according to claim 7, wherein
the selecting unit selects a feature region in which a difference between a highest value of display brightness in the first image and a highest value of display brightness in the second image is greater than a threshold value, as the attention region.

11. The display control device according to claim 7, wherein
the selecting unit selects a feature region in which a difference between a contrast in the first image and a contrast in the second image is greater than a threshold value, as the attention region.

12. The display control device according to claim 1, wherein
the at least one memory and the at least one processor further function as a generating unit configured to generate 1) a histogram for each of the one or plurality of feature regions in the first image, and 2) a histogram for each of the one or plurality of feature regions in the second image,
the histograms are graphs representing a count of pixels for each gradient value, and
the selecting unit selects the attention region on a basis of the histograms generated by the generating unit.

13. The display control device according to claim 1, wherein
the first dynamic range is a high dynamic range (HDR), and
the second dynamic range is a standard dynamic range (SDR).

14. The display control device according to claim 1, wherein
the display control unit controls the display to indicate the attention region by superimposing a frame showing the attention region on the first image or the second image.

15. The display control device according to claim 1, wherein
the display control unit controls the display to indicate the attention region by filling in the attention region in the first image or the second image, or by representing the attention region in a striped form.

16. A display device, comprising:
the display control device according to claim 1; and
a display that displays the first image and the second image, and indicating the attention region, under control of the display control device.

17. A display control method, comprising:
acquiring
a first image that is an image having a first dynamic range, and
a second image that is an image having a second dynamic range that is narrower than the first dynamic range, and is an image representing content that is same as content represented by the first image;
selecting, in a case where the first image and the second image include one or a plurality of feature regions, at least one of the one or plurality of feature regions as an attention region, on a basis of a count of gradient values of pixels used in each of the one or plurality of feature regions; and
controlling a display to display the first image and the second image, and to indicate the attention region.

18. A display control method, comprising:
acquiring
a first image that is an image having a first dynamic range, and
a second image that is an image having a second dynamic range that is narrower than the first dynamic range, and is an image representing content that is same as content represented by the first image;
selecting, in a case where the first image and the second image include one or a plurality of feature regions, at least one of the one or plurality of feature regions as an attention region, on a basis of a display brightness of each of the one or plurality of feature regions in the first image and a display brightness of each of the one or plurality of feature regions in the second image; and
controlling a display to display the first image and the second image, and to indicate the attention region.

19. A non-transitory computer readable medium that stores a program, wherein the program causes a computer to execute a display control method, the display control method comprising:
acquiring
a first image that is an image having a first dynamic range, and
a second image that is an image having a second dynamic range that is narrower than the first dynamic range, and is an image representing content that is same as content represented by the first image;
selecting, in a case where the first image and the second image include one or a plurality of feature regions, at least one of the one or plurality of feature regions as an attention region, on a basis of a count of gradient values of pixels used in each of the one or plurality of feature regions; and
controlling a display to display the first image and the second image, and to indicate the attention region.

20. A non-transitory computer readable medium that stores a program, wherein the program causes a computer to execute a display control method, the display control method comprising:
acquiring
a first image that is an image having a first dynamic range, and
a second image that is an image having a second dynamic range that is narrower than the first dynamic range, and is an image representing content that is same as content represented by the first image;
selecting, in a case where the first image and the second image include one or a plurality of feature regions, at least one of the one or plurality of feature regions as an attention region, on a basis of a display brightness of each of the one or plurality of feature regions in the first image and a display brightness of each of the one or plurality of feature regions in the second image; and
controlling a display to display the first image and the second image, and to indicate the attention region.
